(19) United States
(12) Patent Application Publication
(10) Pub. No.: US 2014/0157579 A1
(43) Pub. Date: Jun. 12, 2014

(54) Networked marketplace for custom 3D fabrication

(71) Applicant: 8 TREE, LLC, League City, TX (US)

(72) Inventors: Arun Chhabra, League City, TX (US); Erik Klaas, Daisendorf (DE); Pia Charlotte Böttcher, Konstanz (DE)

(73) Assignee: 8 TREE, LLC, League City, TX (US)

(21) Appl. No.: 13/708,971

(22) Filed: Dec. 8, 2012

(51) Int. Cl. G06F 17/00

(52) U.S. Cl. CPC G06F 17/00; G06Q 30/0611
USPC 29/592; 705/26.4

(57) ABSTRACT

3D fabrication and rapid prototyping can quickly produce tightly toleranced arbitrary shapes in single units or small quantities. Yet its adoption has been limited in some promising market areas (for example, medical and dental prosthetics). Such products require diverse specialized process sequences that historically involve multiple vendors in long, close, service-intensive relationships. An online marketplace more evenly balances capacity utilization and negotiating strength within these complex supply chains while allowing preservation of existing relationships and service levels. Marketplace software embodiments enable any member of a supply chain to request a quotation for any stage(s) of a fabrication, invite bids, negotiate, award the project, and track its progress. Participants post, view, and collaboratively edit 3D point clouds generated by measurements or CAD. Options include directories, fora, automated regulatory compliance measures (privacy, long-term archival, data reporting), and structured-light metrology instruments configured to upload editable data directly to the marketplace.

### RELATED APPLICATIONS:

This application is related to U.S. patent application Ser. No. 13/549,494 (E. Klaas) filed on 15 Jul. 2012, the content of which is incorporated herein by reference.

### FEDERALLY SPONSORED RESEARCH AND DEVELOPMENT

None

### APPENDICES

None

### BACKGROUND

Related fields include data processing for business management (particularly for electronic negotiation, supply or demand aggregation, item configuration or customization, and collaborative creation of a product or service), three-dimensional computer graphics processing (particularly manipulation of object processing and display attributes), and data processing for networked business administration and commerce.

Three-dimensional fabrication and rapid-prototyping technology (collectively, “3D-fab”) has revolutionized the fabrication of precision items with complex shapes. Additive fabrication, for example the various types of 3D printing, can easily produce parts that were difficult or impossible to make with subtractive technologies such as traditional milling and turning. Virtually anything that can be expressed as a 3D model can be produced by these techniques, and the equipment has become affordable and operable for small shops.

When first introduced, these techniques were mostly used for initial proof-of-design prototypes and scale models. With decreasing costs and increasing ease of use, reliability, versatility, variety of available materials with desirable properties (plastics, ceramics, metals), and expertise within the user community, 3D-fab is more and more frequently used for production. If the desired material is available, 3D-fab for production is most practical when production quantities are small, when tolerances are tight, and when parts are complex or their shapes are difficult to make using older techniques. For example, parts that mimic or interface with parts of humans, plants, or animals are not easily described by the classical dimensioning systems (radii, lengths, angles) around which traditional machine tools operate.

A number of factories and smaller shops offer 3D-fab services. Some of these accept 3D computer-aided design (CAD) files sent by customers over the Internet. A few offer access to 3D CAD software for online design. Most of these providers operate under a closed business model, facilitating online access only to their own offerings. As each of these providers has particular specialties, customers must do significant research to find the right vendor for their type of product. After some promising vendors are identified, lead-times may vary greatly; at any given time, some vendors may be backlogged while others are underutilized. Obtaining this information takes even more of the potential customer's time. Therefore, the 3D-fab industry would benefit if would-be customers could access vendors' present capabilities, backgrounds, pricing, and availability in a way that facilitates quick, easy, accurate comparisons. The industry would also benefit from providing vendors with the ability to monitor both the overall market and specific current opportunities to make and sell products that leverage their particular specialties.

Medical, dental, and veterinary prosthetics and restorations (collectively, “prosthetics”) are one example of a product type that is potentially well-suited for 3D-fab. Generally, each part needs to be customized for one particular patient. Comfort, utility, and aesthetics depend on a perfect fit. Organic shapes such as teeth, bones, limbs, and ears (including the ear canals to which custom hearing aids are fitted) have many compound surface curves and other complexities. They often require (or at least benefit from) non-uniform density or composition. These are all difficult to achieve with more traditional fabrication techniques. The difficulty historically resulted in long waits for suffering patients, followed by large bills. In addition, some traditional methods for making prosthetics include a single-use mold or die that must be broken to extract the manufactured article. If the prosthetic is later damaged, the process must be repeated from the beginning For items made using 3D-fab, replacements can be made immediately if the CAD or computer-aided manufacturing (CAM) file is still available. Patients in need of prosthetics could potentially receive them sooner, with better fit, reduced expense, and ease of replacement, if the prosthetics could be made by 3D-fab.

The specifications for making a prosthetic often represent a combination of measurement and design. The parts of the patient's body that interact with the prosthetic are measured. The parts being replaced, when available in acceptable condition, may also be measured. Measurement accuracy can be critical to comfort and function. Other parts of the prosthetic are designed. They may be optimized for particular functions or aesthetics, sometimes improving on the original. For example, because natural teeth become shorter by wearing down over a lifetime of use, dentures can be designed to make the wearer look younger by making the replacement teeth slightly longer than the originals. The need for the product to be aesthetically pleasing as well as serving a practical purpose makes a prosthetic a work of art as well as engineering.

Some measurements for prosthetic specification are done directly on the patient. Others are done from plaster casts and other types of physical impressions of the body part (or, in some cases, adjacent body parts. Three-dimensional optical metrology (e.g. laser scanning and structured-light projection, collectively “optical metrology”) can capture the exact contours of a surface as a digital “point cloud” in a fraction of a second. In some cases, this may obviate the need to make a physical impression at all. In cases where taking the impression is still necessary, optical metrology of the impression can capture all the necessary detail in a digital form that is much easier, less expensive, and safer to ship and store than the physical impression itself Therefore, wider use of optical metrology for the measurement steps of making prosthetics could improve accuracy while simplifying logistics throughout the supply chain.

The business of making prosthetics has some particular nuances not found in general manufacturing. At the core of these nuances is the extremely personal and intimate nature of the product. Patient privacy (at least for human patients) has always been generally desired, and is now regulated and enforced in many jurisdictions. At the same time, many jurisdictions require patient records (often including physical impressions and models) to be retained for decades in case of a forensic need; they must be kept intact, but they must also be kept secure, which adds the maintenance of a large, private, locked, climate-controlled, frequently-cleaned and carefully organized building to the overhead cost of the business.

Business relationships in these fields tend to be long-term and trust-intensive. Patients return to practitioners they know and trust. Practitioners maintain relationships with laboratories they know and trust. These laboratories, which are often small, local establishments, offer copious individual attention, technical advice, and retained institutional knowledge about the practitioners' histories and preferences. If the labs do not have design and manufacturing capabilities in-house, they will form similar close-knit relationships with outside providers based on perceived talent, flexibility, and reliability. Because of the time and effort required to build these relationships, many customers, particularly small concerns, sole-source each type of product from a single vendor. If the sole source becomes overbooked, encounters production problems, or exits the business, the customer can face severe delays while trying to find another source.

The fundamentally personal and somewhat artisanal nature of prosthetics, the stringent and often complex regulatory requirements, and the prevalence of particular and quasi-closed relationships throughout the supply chain prevent an easy adaptation of this business to the usual type of open online marketplace. Overarching conservatism, as well as costs and learning curves that still remain rather steep for small establishments, may be slowing the adoption of new technologies such as 3D-fab and optical metrology. Nevertheless, patients and the industry as a whole could benefit from an online marketplace where optical-metrology measurement files, scrubbed clean of privacy-implicating information, could be uploaded as part of a request for quotation (RFQ); where 3D-fab providers could browse and bid on RFQs that matched their capabilities and capacities; and where laboratories could source advanced technologies and specialized services from other providers and still provide the one-on-one expert attention prized by practitioners. Small laboratories could keep technology-minded customers without needing to buy their own equipment and hire skilled operators. Overbooking or technical difficulties at smaller labs could be handled by sourcing the excess work to providers with excess capacity. Design and 3D-fab facilities could leverage economy of scale to participate in the industry without needing to disrupt closed circles of existing practitioner/lab relationships. Finally, such a system, if crafted to be widely accepted in the industry, could deliver advanced prosthetics more cost-effectively to more patients in less time.

Such a 3D-fab-marketplace for prosthetics could help alleviate the problem of rapidly growing healthcare costs. A well-made prosthetic can make an enormous difference in a patient's ability to carry out daily tasks, and thereby in the patient's productivity, independence, and morale. Yet many patients requiring prosthetics are either publicly supported (wounded veterans) or low-paid workers in dangerous fields (mining, logging, construction). Long waiting periods for custom articles can be extended by long preliminary processes to satisfy hard-pressed payers that the expense is warranted. The marketplace would enable customers to easily find the best combination of delivery time and price. If the resulting increases in efficiency result in lower cost, the prosthetic may become eligible for approval through a quicker, simpler preliminary process.

### SUMMARY

Some embodiments of an online marketplace for custom 3D-fab (“Marketplace”) enable fuller utilization of excess manufacturing capacity by making RFQs visible to a wide range of would-be bidders. Some embodiments facilitate distributing different parts of projects to different providers to alleviate bottlenecks and expedite delivery. Some embodiments include software for competitive bidding, negotiation of terms, and specification sharing to streamline communication throughout the supply chain. Some embodiments include software for billing, logistics, and tracking, relieving collaborating members of a supply chain from duplicating each other's efforts.

Some embodiments of the Marketplace include easy-to-use optical metrology apparatus for making quick, accurate measurements relevant to specifications in the RFQ, diagnosing any problems in the measurement or target, and uploading the point-cloud and other specifications distilled from the measurement into the RFQ file.

Some embodiments are tailored for prosthetics and other industries with similar characteristics of personally significant products, sensitive information, specifications that combine design with precision measurement, long-standing close-knit vendor/customer relationships. Practitioners need not be forced to choose between the superior service of small laboratories and the superior technology of larger factories; some Marketplace embodiments facilitate RFQs by labs to factories who perform the advanced processes, then deliver the products to the labs for artisanal finishing. Some Marketplace embodiments automatically remove all patient-identifying data from RFQs and other records, encrypt transmissions of sensitive information, and edit the measurement point-cloud to retain all data necessary to the project but delete anything else, such as non-essential images of adjacent parts of the patient's body.

### BRIEF DESCRIPTION OF THE DRAWINGS

FIG. 1A conceptually illustrates a simple custom-fabrication transaction.

FIG. 1B conceptually illustrates the transactions that may be involved in making a prosthetic.

FIG. 2 is a schematic of the stages of custom fabrication that could be procured through an online marketplace.

FIG. 3 is a schematic of a distributed communication network facilitating the 3D-fab marketplace.

FIG. 4 is a schematic of the types of software used in an embodiment of the marketplace.

FIG. 5 is a graphic representation of some points in an STL file.

FIG. 6A shows a structured-light scanner measuring a surface. FIG. 6B shows a structured-light scanner displaying measurement results and additional information on the measured surface.

FIG. 7 is a simplified illustration of a graphical user interface for editing 3D measurements.

FIGS. 8A-8C are examples of navigation screens for using the marketplace.

### DETAILED DESCRIPTION

This Description will explain the intricacies of some transactions involving 3D-fab and peripheral processes; describe embodiments of an online-marketplace system that streamlines these transactions;

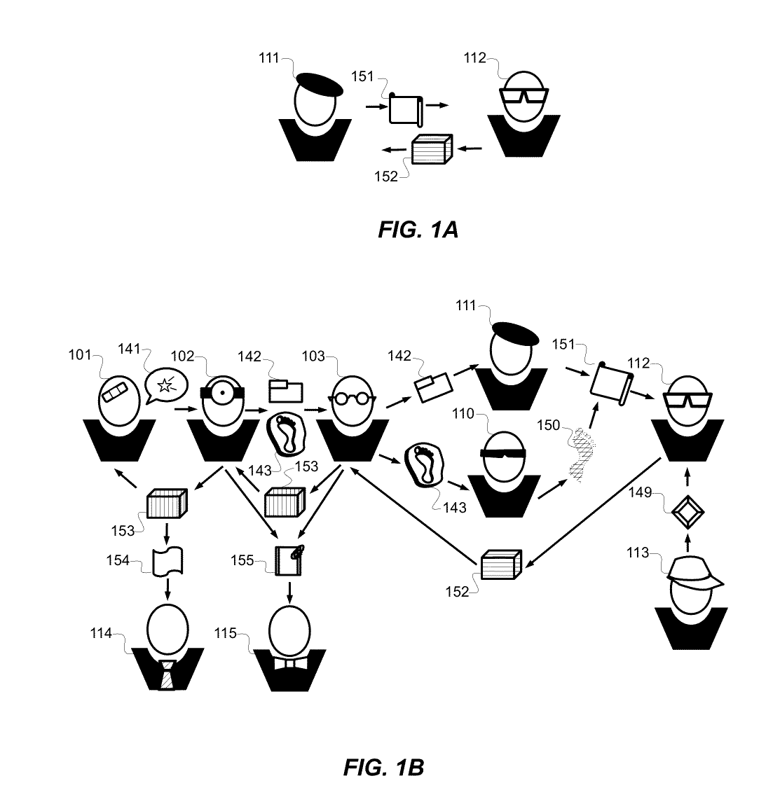

FIG. 1A conceptually illustrates a simple custom-fabrication transaction. Designer 111 generates 3D-fab specification 151 and sends it to manufacturer 112. 3D-fab specification 151 may be in digital form and transmitted over a communications network such as the Internet; sent by electronic mail, uploaded to a website, etc. Manufacturer 112 makes the shaped part 152 according to specification 151 and delivers it to designer 111. Shaped part 152 may be “finished” and ready for immediate use, or may require further processing steps done elsewhere. Somewhere in the process, manufacturer 112 is paid for shaped part 152 (step not illustrated).

FIG. 1B conceptually illustrates some of the transactions that may be involved in making a prosthetic. Because of the need for special expertise in multiple arts and sciences, quite a few more parties are involved in the supply chain besides designer 111 and manufacturer 112, and many more objects can change hands besides specification 151 and shaped part 152. This process begins with patient 101, who communicates a need 141 to practitioner 102. Practitioner 102 generates a diagnosis 142 based on need 141 as interpreted through the expertise of practitioner 102 and may prepare one or more measurements 143 of those body parts of patient 101 that will interact with the prosthetic. Here the measurements of the patient are illustrated schematically by a physical impression (footprint), but X-ray tomography, optical scanning, or other types of medical imaging may be used besides or instead of a physical impression.

Practitioner 102 sends diagnosis 142 and measurements 143 to laboratory 103. Laboratory 103 sends diagnosis 142 to designer 111. If patient measurements 143 are not yet in 3D digital form suitable for including in a specification 151, and laboratory 103 is not equipped to convert them, laboratory 103 may send measurements 143 to scanning service 110. Scanning service 110 produces 3D point cloud(s) 150, which are combined with the designed aspects of the prosthetic to produce specification 151. Specification 151 is transmitted to manufacturer 112. In some cases, specification 151 may require manufacturer 112 to source specialized material 149 from material supplier 113.

Manufacturer 112 makes shaped part 151 and delivers it, often drop-shipping directly to laboratory 103. Laboratory 103 may perform finishing operations, such as coloring, on shaped part 151 to produce finished prosthetic 153. Laboratory 103 delivers finished prosthetic 153 to practitioner 102. Manufacturer 112, laboratory 103 or practitioner 102 may measure the finished prosthetic with a 3D scanner, comparing the results with a reference measurement or design as part of the quality-assurance process. Finally, practitioner 102 presents the finished prosthetic to patient 101 along with fitting, training, and follow-up services.

The “information chain” may have additional branches that depart from the supply chain. Invoice or receipt 154 for a charge associated with finished prosthetic 153 may need to be sent to an insurer or other payer 114. Compliance-related information 155, which may be related to either medical or manufacturing standards, may need to be sent to a regulatory representative 115.

As soon as the information needed for design and manufacture of the prosthetic is put into digital form, the cost of its transmittal and storage drops dramatically. If a 3D point-cloud of the patient measurements could be generated at the laboratory, or even at the practitioner's site, it could be shared with designers and manufacturers with greater ease and less expense than the impressions or constituent measurements. At the same time, patient privacy could be better protected.

Easy sharing and privacy protection may seem inherently contradictory. However, impressions, X-rays, and other medical images almost always include more information than is needed to make a prosthetic. Unnecessary context surrounding the body/prosthetic interface area(s) may inadvertently increase the risk that an unauthorized viewer might identify the patient. For instance, distinctive healed fractures, fillings, surgical pins, or older prosthetics may be visible in the raw images but not needed for design of the current prosthetic. Instead of copying, shipping, and sharing these potentially patient-identifying items, a 3D point-cloud could have all unnecessary context and peripheral details removed before sharing the file. Thus, everything needed for the process is shared in its most useful form, and possibly-risky extraneous information is not shared at all.

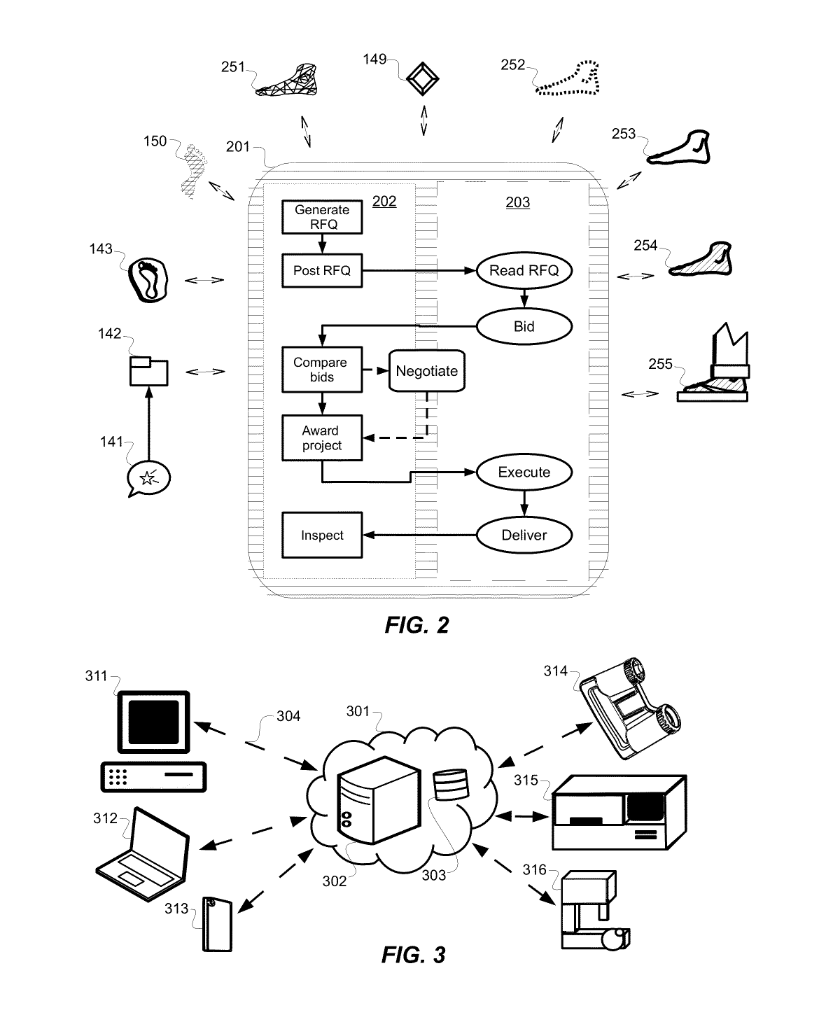

FIG. 2 is a schematic of the stages of custom fabrication that could be procured through an online marketplace. The online-marketplace setting 201 supports various types of communication between a customer 202 and vendor 203. The set of communication functions illustrated here is a non-limiting example. Customer 202 generates an RFQ and posts it for potential vendors' review. The RFQ can contain any information describing the type and complexity of the task; text, numbers, images, 3D CAD files, or one or more point-clouds resulting from 3D metrology. The posting can be “open” to any vendor who wants to bid, or restricted to a subset of “invited” vendors. The eligible vendor 203 reads the RFQ and, if interested, submits a bid. Customer 202 compares the collected bids, and either (1) awards the project to a vendor 203 based on the bids or (2) enters a negotiation stage with one or more vendors 203 before awarding the project. Chosen vendor 203 receives access to any further details necessary for carrying out the project (which may include larger or additional 3D files), executes and delivers the project for customer 202's inspection. Further steps (not shown) of rejection, return correction, and acceptance can also be handled through the marketplace.

Some embodiments of the online marketplace can handle the RFQ/bid/award/execute/deliver/accept cycle for more than just the 3D-fab stage 252. A diagnosis 142 can be obtained this way; for instance, if patient need 141 is communicated to a general practitioner, the general practitioner can find a suitable specialist in the marketplace. Impressions and other models or un-digitized images 143, point-clouds and other 3D digitized measurements 150, design models 251, and materials 149, all precursors to the actual fabrication, can be sourced through the marketplace. Processes that occur after initial fabrication, such as finishing and texturing 253, coloring 254, and final fitting for wearability 255 can also be sourced through the marketplace. Any combination of these stages can be sourced to vendors with multiple capabilities.

FIG. 3 is a schematic of a distributed communication network facilitating the 3D-fab marketplace. One or more servers 302 and information-storage devices 303 are interconnected in “computing cloud” 301 and may be accessed by various remote devices through physical or wireless connections 304. The remote devices that can access the online marketplace include a CAD workstation 311, a portable computer 312, a mobile smart-phone or tablet 313, a 3D metrology scanner 314, a rapid-prototyping apparatus 315, and a conventional milling machine or other machine tool 316.

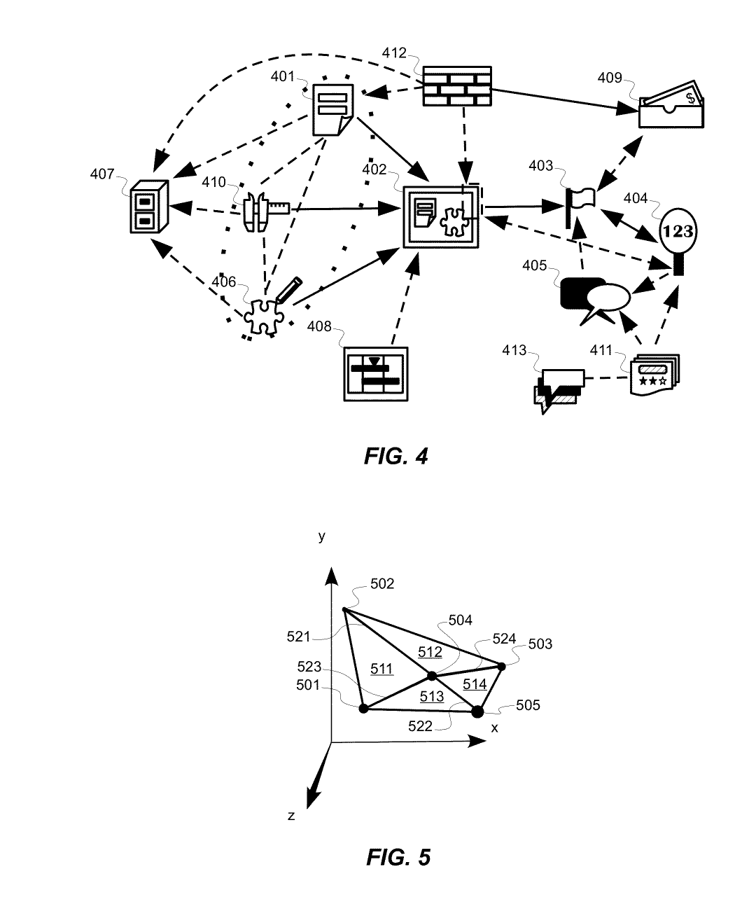

FIG. 4 is a schematic of the types of software used in an embodiment of the marketplace. Posting and viewing function 402 and notification function 403 are central to many of the transactions. For example, an RFQ prepared with document-drafting function 401 could be uploaded to posting/viewing function 402. In some embodiments, document-drafting function 401 provides form fields or prompts the customer to select tags from a standardized set, tags to ensure the RFQs are complete, sufficiently descriptive, and easy for posting/viewing function 402 to sort and classify accurately. If measurement 410 or design 406 already exists, its three-dimensional point cloud may be posted as part of the RFQ. If it does not (for example, someone is posting an initial RFQ for a measurement or a design), the customer can have the software associate those graphical files with the documentary part(s) of the RFQ later, as they become available.

When a new RFQ goes up, it may be displayed to vendors by posting/viewing function 402. In some embodiments, anyone may view them; in others, viewing access is controlled by subscription, by vendor filters imposed by the customer, or by other criteria. In some embodiments, notifications may be sent by notification function 403. The notification can take many forms. A completely open RFQ can have a notification displayed on the marketplace home page, or a message sent to all subscribing vendors. Alternatively, the customer can narrow the field by imposing a vendor filter (“notify only these specific vendors,” “notify only domestic vendors,” etc.) or by the vendor (“only notify me when these specific customers post,” “only notify me about certain project types,” etc.). Where the RFQ includes a three-dimensional point cloud, posting-viewing function 402 allows vendors to view and download the file for evaluation and bid preparation. Bidding function 404 commences once the interested vendors know about the RFQ. Bidding can proceed as illustrated here through multiple notifications transmitted between the customer and bidders. Depending on the embodiment, competing vendors may or may not be notified of each other's bids, or the customer can decide whether or not the competing vendors see each others' bids. In other embodiments, bidding function 404 can display on posting/viewing function 402, either publicly or in one or more separate areas protected by security function 412 (e.g. accessible only with a password). Some embodiments support negotiation function 405 within the bidding process, enabling private communication on a channel supported by notification function 403.

Some embodiments also maintain a directory function 411. Vendors, customers, or both may have directory entries that may include practice descriptions, sizes, locations, examples of work, number of projects completed through the marketplace, “Immediate Capacity” or “Rush OK” checkboxes, links to external assurances such as licenses and financial indicators, or ratings from others who have worked with them in the marketplace. Directory function 411 can interact with a number of the other functions. Directory entries can enhance filtering of RFQ notifications (“only ratings of 3 or more stars,” “only those with “Rush OK” currently active“), help inform bidding and negotiation processes, and, in embodiments where practitioners are included, facilitate referrals and second opinions. Some embodiments host a forum function 413, either adjunct to or instead of directory function 411. Forum function 413 facilitates threaded discussions on common technical topics among vendors, customers, or both, and is another way to build connections, recognition, and reputation within the marketplace.

Once a project is awarded and acceptance of the bid is relayed to the chosen bidder, the parties enter into a contract for execution of the project. In some embodiments, document-drafting function 401 includes standard contracts with form-fields for variable terms such as price, delivery date, and time to pay.

During the course of the project, additional measurements can be provided through measurement-upload function 410 or design-modification function 406. In some embodiments, design modification may be a simple upload of a revision; others may provide online design software, optionally with multi-editor collaborative capabilities, change control protocols, and access control to facilitate, among other things, a 3D product design using information from a measured three-dimensional point cloud. Some embodiments provide for conversion of 3D point-clouds of designs, measurements, and their combinations into formats suitable for 3D fabrication, conventional machining, or other programmable processes using 3D shape information.

In some embodiments, progress of the project (including delivery) may be tracked and managed through simple notifications (”your order has been tested and is ready for shipping,” “we have looked over the test results and approve the next step,” etc.). In other embodiments, the marketplace software may include an online project-tracking function 408, allowing the customer and one or more collaborating vendors to track progress by collecting status reports or test results to be viewed in posting/viewing function 402, optionally in a private area protected by security function 412.

Upon delivery or upon a progress-payment milestone, a payment is due. Some embodiments support a payment function 409 to receive the payment, which may be proprietary to the marketplace or interface with the software of an entity that specializes in online payments. Optionally, payment function 409 may be set up by the customer to send copies of payment records to an insurer or other payer. Payment transactions and financial data are protected by security function 412.

Some embodiments include an archival function 407. Designs 406, measurements 410, and documents 401, including three-dimensional point clouds, can be retained in long-term storage archives through archival function 407, protected by security function 412 (e.g. automatic backup, disaster-recovery, anti-virus, controlled access). In some embodiments, an archive can be configured to include all the data needed to manufacture a replacement article. This can be done much more cost-effectively than the current practice of obtaining climate-controlled and otherwise protected storage space for fragile impressions and models. In some embodiments, retention times default to the minimum required by the regulations of the customer's or vendor's industry or jurisdiction, and the customer has the option of setting a longer time. Archival function 407 may also compile statistics on the archives; for example, it could enable a customer posting an RFQ or a vendor preparing a bid to see statistics on winning bids for past RFQs with similar characteristics stored as archives.

Some embodiments of security function 412 include anonymization and encryption measures designed to redact potentially sensitive patient-identifying information from both graphic and non-graphic RFQ materials before they enter the marketplace. For example, all projects may be given random or auto-sequential identifier codes, so that only the original practitioner ever knows the patient's identifying data. The RFQ forms in document-drafting function 401 may lack any fields for inputting patient information. In enhanced embodiments, a text analyzer may look for words in the documents that look like personal names and, upon finding one, display a message “Do not include patient names. Did you mean to write [found word or phrase]?” Similar filters could check for other potentially restricted identifiers such as Social Security or driver-license numbers. Optionally, the measurement-upload function 410 may provide a way to crop all non-essential areas out of the measurement (e.g. the rest of the patient's face if only the upper front teeth are being reconstructed).

Some embodiments support automated vendor filters to prevent accidental violation of a regulation of the customer's industry or jurisdiction. For example, in jurisdictions where not even anonymized medical data may be exported, embodiments of the marketplace may provide automatic notification filtering to domestic vendors and measures to restrict archival to domestic servers. In another example, certain types of customers or articles recognized in the RFQ could trigger a vendor filter restricting display or notification to vendors with a required credential,

In some embodiments, compliance information such as test results, procurement processes, and vendor certifications may be searched for and extracted from archives by features of archival function 407 after a project is finished. In others, compliance information may be searched for and extracted as a project progresses by features of document-drafting function 401 and project-tracking function 408. Reports or summaries of the extracted information can be made available to a vendor's or customer's designated regulatory representatives through notification function 403 or a part of posting/viewing function 402 protected by security function 412. In some embodiments, the regulatory representatives may post or verify certification information for compliant entities in directory function 411.

3D data files can be large, presenting a challenge to storage space and transmission bandwidth. The common term “point cloud” for a 3D file can be inaccurate in cases where a file not only needs to contain a group of points, but also information on how the points are connected. In complex shapes such as sets of fingers and toes or the roots of a tooth, omitting the connection information and relying on assumptions such as “each point is connected to its nearest neighbors” can sometimes cause errors; a nearest neighbor to a point on the edge of a toe may actually be on the facing edge of a different toe. Different software platforms that demand different file formats can also cause confusion, delays and conversion errors for multiple parties working from the same model.

Some common formats have emerged, such as STL. FIG. 5 is a graphic representation of some points in an STL file. The points 501-505 of the point cloud are connected by triangles 511-514. (The large and small sizes of points 501-505 are intended to represent near and far z-locations.) STL files store the triangles with all their points, so that points common to two or more triangles are stored multiple times. Point 504 is part of triangles 511, 512, 513, and 514, so 4 copies of point 504 would be stored in STL. Likewise, point 501 would be stored twice; once as part of triangle 511 and once as part of triangle 513. Points 502, 503 and 505 would also be stored twice.

An STL-formatted file may only be needed for CAM processes such as milling or 3D printing. Some embodiments of the marketplace strip out one or more of the copies of repeatedly-stored points, reducing the file size by values near 50% while retaining enough information to unambiguously regenerate the STL file when it is needed. Other vendors, such as those doing design-modification, can work more rapidly with the smaller files. Some embodiments of the marketplace include a native CAD function that can read the compressed files.

Some embodiments also shrink the 3D files by detecting planar regions and combining adjacent coplanar triangles in that region into larger triangles or other larger shapes. In FIG. 5, line 522 from point 504 to point 505 is a continuation of line 521 from point 502 to point 504; they form a composite line “521+522.” Triangles 511 and 513 share line 521+522 and point 501; therefore they are coplanar and could be combined into a single triangle with vertices 510, 502, and 505. Triangles 512 and 514 could also be combined into a single triangle for the same reason.

“Planar” and “coplanar” are defined by the tolerances on that region of the part. Relatively loose-toleranced regions, such as the cheek-ward or tongue-ward face of a molar crown, may use a more relaxed definition of “coplanar” than the tighter-toleranced surfaces facing neighboring teeth. If the points in FIG. 5 were located on a non-critical part of the surface, lines 523 and 524 might be “close enough” to collinear even though their slopes are slightly different where they meet at point 504. In that case, triangles 511-514 could be combined into a single quadrilateral with vertices 501, 502, 503, and 505. Redundant vertices can then be stripped from the combined triangles or other polygons.

Where measurements are part of the specification of a 3D-fab project, they can be digitized and uploaded by various techniques. Several approaches have been developed for constructing 3D measurements from 2D images taken from different angles. They rely on identification of homologous points (the same object point appearing in the different images). The construction begins with the homologous points; other points between the homologous points are interpolated. If the surface to be measured shows the 2D imager a distinct pattern or texture, accurate identification of homologous points becomes easier. The interpolation is more accurate if no peaks, valleys, or inflection points of the surface contour fall between homologous points. Lack of pattern or texture, or jaggedness or randomness of surface contour, can cause errors in the 3D construction.

Optical 3D metrology, where feasible, allows the 3D-from-2D construction step to be skipped and removes that opportunity to introduce error. Regardless of texturing, patterning, or smoothness of contour, if a point on the surface is illuminated (e.g. by a scanning beam or a structured-light pattern) and the light returning from it is captured, that point's coordinates can be measured directly.

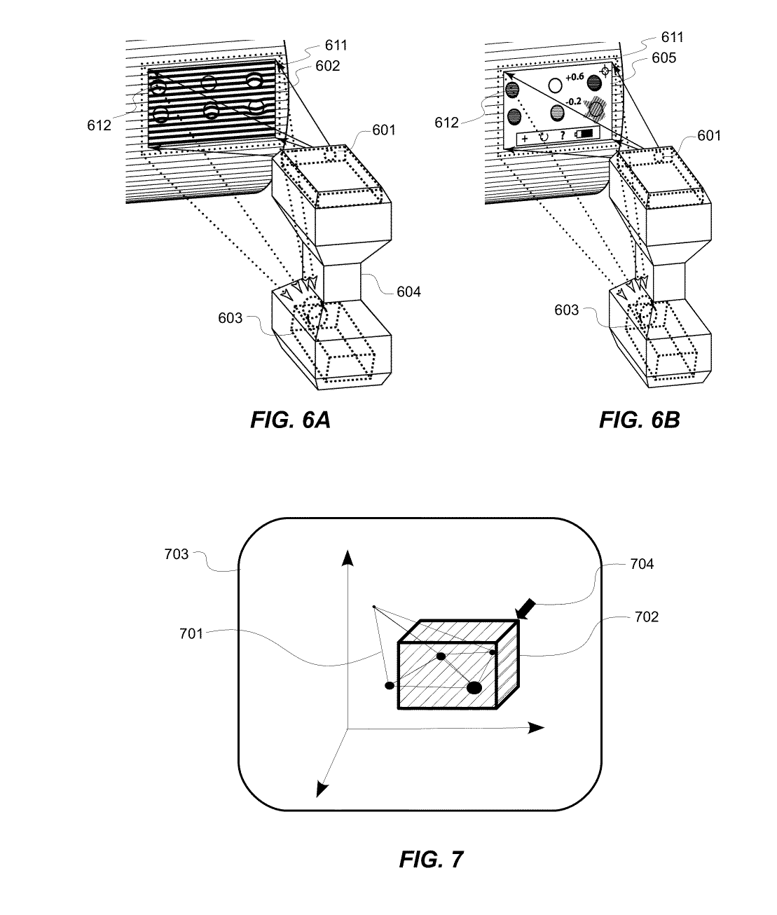

FIG. 6 shows a structured-light scanner measuring a surface. This is the type of scanner described in U.S. patent application Ser. No. 13/549,494 (Klaas). Projector 601 projects a structured-light pattern 602 onto the surface 611 that is being measured. Here, structured-light pattern 602 is a sharp-edged “square-wave” stripe pattern, but it could be a soft-edge sinusoidal stripe, a white-noise pattern, or any other pattern on which deviations are easily recognized. Topographical features 612 create deviations between the projected pattern 602 as observed on surface 611 and the original pattern in the object plane of projector 601. A camera 603 captures the deviated pattern 602 from surface 611. In the illustrated instrument, projector 601 and camera 603 are built into a portable housing 604.

Embodiments of housing 604 can be used on simple custom mounts, placed on existing tables or shelves, or even hand-held; the projection-and-capture cycles may be completed in such a short time that small involuntary motions of the user's hand or the target surface do not affect the measurement results. These embodiments may be especially convenient for use in medical practitioners' offices or hospital rooms where space is limited and the target surface may be on a living body. Ruggedized versions may be adapted for mobile, rural, or military environments.

A processor (not shown) compares the image captured by camera 603 to a scaled, corrected version (knowing the working distance to surface 611 and the angle between the optic axes of projector 601 and camera 603) of the original pattern at the object plane of projector 601. If object 611 were perpendicular to the optic axis of projector 601, and flat (within the instrument's resolution), the patterns would be identical (e.g., the stripes in pattern 602 would be perfectly straight). The deviations (e.g. crooked sections of the stripes) are analyzed to yield the heights or depths of surface features such as 612. Typically, a quick succession of different images 602 are projected and captured for each surface measured. The original patterns vary in some characteristic such as spatial frequency, orientation, offset, or illumination spectrum.

FIG. 6B shows a structured-light scanner displaying measurement results and additional information on the measured surface. The measurement is finished and analyzed by the processor (not shown), which causes projector 601 to project a result display 605 on surface 611. Some embodiments use the same image generator (e.g. a programmable MEMS, LCD, or LCOS array) in the object plane of projector 601 to generate the structured-light measurement patterns 602 and the result display 605. Result display 605 shows where the surface deviations are, for example surface feature 612, graphically using false color or false patterns. Numerical values for the deviations, other data such as timestamps or part numbers, and navigation to calibration or statistical projected screens can be included on the display. By capturing the display screen with camera 603, these results can be uploaded to the marketplace, along with the three-dimensional point cloud resulting from the measurement, through a network connection from the processor. Some embodiments of the metrology instrument have built-in processors and network connections to upload the measured point-clouds, other summary, statistical or labeling information, or both directly to the network. Other embodiments of the metrology instrument can communicate these results to a processing device such as a computer, tablet or smart-phone; the processing device can in turn upload the results to the network. In other embodiments, applications running on the processor auto-fill specification forms with result numbers pulled directly from the measurement.

The illustrated example compares the measured contours to stored ideal surfaces and tolerances; thus, as well as using this structured-light metrology instrument to measure a dental impression and upload it to the marketplace as part of an RFQ for a reconstruction, the dentist or small dental lab can also use the instrument to measure the differences between the finished reconstruction and the impression

Additional software in some embodiments allows editing of the measurements before uploading them to the marketplace. FIG. 7 is a simplified illustration of a graphical user interface (GUI) for editing 3D measurements. The measured point-cloud 701 is mapped on graphic display 703, and the view can be rotated to show any side of the 3D shape. The user manipulates cursor 704 to select parts of the surface to be inside selection shape 702, shown here as a rectangular box (though other shapes are possible and can be advantageous in some applications).

In various embodiments, the selection shape can be altered in size and shape as well as position; can be subtractive (“remove all the points inside the shape”) or preservative (keep the points inside the shape and remove all the rest“). Some embodiments add points where the existing point-connecting lines meet the boundaries of the shape, providing a neat geometrical cut-off. Using editing software like this, the user can remove any measurement artefacts and all extraneous measured points and remove any ambiguity about which parts of the point-cloud are relevant to the 3D-fab project. Besides reducing file size, reducing confusion among bidders, and relaxing the constraints on measurement alignment, this feature can help protect patient privacy.

Some embodiments of the GUI enable the user to selectively identify parts of the measurement (or design) for tighter or looser tolerances, application of texture and color, or other localized specifications. Other versions of the selection shape can be used, or other visually appealing tools such as an onscreen “pencil” or “paintbrush.” Some embodiments of the GUI facilitate the marking (by an originator), automated recognition (by a downstream user) of the most critical features of a 3D file, such as the preparation line where a dental crown joins the stump of the original tooth. A method for smoothing or shifting selected lines or surfaces may also be provided.

Embodiments of the marketplace can be made scanner-agnostic, converting structured-light, scanning-laser, x-ray tomography, or 3D-from-2D data into one or more common formats (e.g. compressed for storage, selected 2D views for quick reference, Digital Imaging and Communications in Medicine (DICOM) or equivalent standards for practitioners and labs, and STL or some other convenient format for job-shops and factories.

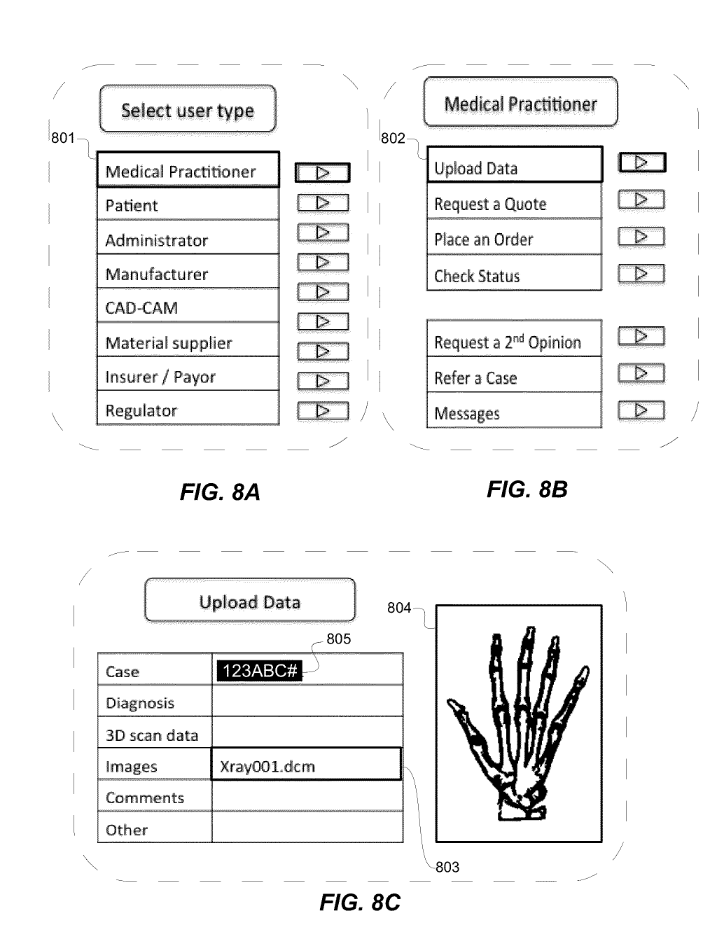

FIGS. 8A-8C are examples of navigation screens for using the marketplace. Navigation screens like this are suitable for use on compact mobile devices as well as computers. FIG. 8A shows a “welcome” screen where a new user can be routed to relevant parts of the software by selecting a user type 801 (“medical practitioner” in the illustration). FIG. 8B shows an initial medical-practitioner screen and typical functions 802 frequently accessed by this kind of user (“upload data” is selected in the illustration). FIG. 8C is an example of an interface a medical practitioner could use for uploading data to add to a new RFQ or existing project. In some embodiments, the user would create an account or log in before reaching this screen. The user enters data filename(s) 803 by typing or browsing, and shown an image 804 (either a thumbnail or a larger, editable image). The system automatically anonymizes the case ID 805.

The embodiments included in this written description and the accompanying drawings are for illustrative purposes only. The scope of patent protection is defined solely by the appended claims.

We claim:

1. A method of facilitating manufacture of a custom article, comprising:
posting a customer's request for quotation on a network,
displaying the customer's request for quotation to a vendor using the network,
transmitting a bid from the vendor to the customer over the network,
relaying a response to the bid from the customer to the vendor over the network, and
enabling a three-dimensional point cloud to be uploaded to and downloaded from the network.

2. The method of claim 1, where the three-dimensional point cloud comprises a measurement.

3. The method of claim 2, where the vendor uses the three-dimensional point cloud to produce either the manufactured article or a computer-aided design for the manufactured article.

4. The method of claim 2, where the measurement is uploaded from a structured-light metrology instrument connected to the network.

5. The method of claim 4, further comprising uploading additional information about the measurement to the network from the structured-light metrology instrument.

6. The method of claim 4, where the metrology instrument interacts directly with the network.

7. The method of claim 4, where the metrology instrument interacts with a processing device, and the processing device interacts with the network.

8. The method of claim 1, further comprising displaying an editable view of the three-dimensional point cloud.

9. The method of claim 1, where
the customer comprises one of a medical patient, a medical practitioner, a laboratory, and a manufacturer, and
the vendor comprises one of a medical practitioner, a laboratory, a scanning service, a designer, a material supplier, and a manufacturer.

10. The method of claim 1, further comprising one of:
providing a private communication channel for negotiation,
sending or posting a status report,
sending or posting a test result,
invoicing a charge,
receiving a payment,
maintaining a directory and
hosting a forum.

11. The method of claim 10, further comprising one of:
invoicing the charge or collecting the payment from a designated payer other than the customer, and
extracting compliance information from the request for quotation, the status report, the three-dimensional point cloud, the test result, the charge, or the directory for review by a regulatory representative, and
adding certification information about the vendor or customer to the directory when submitted by the regulatory representative.

12. The method of claim 1, further comprising storing an archive comprising the three-dimensional point cloud.

13. The method of claim 12, where the archive comprises all the data needed to manufacture a replacement for the article.

14. The method of claim 12, further comprising retaining the archive for a default period determined by archival regulations of the customer's or vendor's industry or jurisdiction.

15. The method of claim 12, further comprising including the archive in a statistical analysis.

16. The method of claim 1, further comprising recognizing and redacting sensitive information in the request for quotation.

17. The method of claim 16, where the sensitive information comprises identifying information about a private individual.

18. The method of claim 16, where the sensitive information comprises part of the three-dimensional point cloud, and redacting comprises use of a graphical user interface.

19. The method of claim 1, further comprising allowing a customer to define a vendor filter, where the displaying of the customer's request for quotation to a vendor is conditioned on the vendor having a characteristic defined in the vendor filter.

20. The method of claim 1, further comprising an automated vendor filter based on a regulatory requirement in the customer's industry or jurisdiction, where the vendor filter is activated by information recognized in the request for quotation.

21. A method of manufacturing a prosthetic, comprising:
receiving a notification that a request for quotation is posted in an online marketplace,
bidding on the request for quotation,
receiving a notification of a project award resulting from a winning bid,
accessing a three-dimensional point cloud of the prosthetic in the online marketplace, where the three-dimensional point cloud comprises a measurement of part of a patient's body, and
configuring the information in the three-dimensional point cloud to drive a numerically-controlled fabrication tool to make the prosthetic.

22. The method of claim 21, where the measurement of part of a patient's body comprises information about adjoining body parts critical to the form, fit and function of the manufactured prosthetic.

23. The method of claim 21, further comprising:
measuring the prosthetic,
comparing the measurement of the prosthetic to the three-dimensional point cloud, and
modifying the prosthetic if the measurement of the prosthetic departs from the three-dimensional point cloud by more than a specified tolerance.

24. A non-transitory information storage medium programmed with data and instructions for an online 3D-fabrication marketplace, the data and instructions comprising:
a posting-and-viewing function comprising a capability to post and view a three-dimensional point cloud,
a document-drafting function comprising a capability to add document content to the posting-and-viewing function,
a notification function responding to events comprising a change in the content of the posting-and-viewing function,
a bidding function making use of the notification function and the posting-and-viewing function, and
a measurement-upload function for adding measurement content to the posting-and-viewing function, and
a user interface facilitating the use of each of the functions to specify, quote, order, manufacture, and deliver an article partially described by the three-dimensional point cloud.

25. The non-transitory information storage medium of claim 24, further comprising one of:
a design-modification function with capabilities comprising one of
combining design content with the measurement content,
modifying the design content or the measurement content,
enabling multiple editors to collaboratively modify the design content,
imposing a change-control protocol on the design content, and
converting design or measurement content into formats suitable for programmable fabrication processes;
a vendor filter configured to be activated in the document-drafting function or the posting-and-viewing function,
a negotiation function deploying the notification function in a private communication channel,
a directory function organizing participant data to be viewed through the posting-and-viewing function,
a forum function facilitating threaded discussion comments to be viewed through the posting-and-viewing function,
a project-tracking function collecting status reports or test results to be viewed through the posting-and-viewing function,
a payment function receiving payments for manufactured articles and services procured through the marketplace and generating records of the payments,
an archival function configured to store data comprising the three-dimensional point-cloud, and
a security function doing one of:
controlling access to selected content of the marketplace, and
anonymizing or encrypting sensitive information sent to, residing in, or sent from the marketplace.

26. The non-transitory storage medium of claim 24, further comprising instructions for storing the three-dimensional point cloud in a compressed format and displaying it in an industry-standard format.
